(19) United States
(12) Patent Application Publication
(10) Pub. No.: US 2012/0078425 A1
(43) Pub. Date: Mar. 29, 2012

(54) NETWORK-BASED OPTIMIZATION OF SERVICES

(76) Inventor: Seth Gardenswartz, Albuquerque, NM (US)

(21) Appl. No.: 13/312,975

(22) Filed: Dec. 6, 2011

Related U.S. Application Data
(63) Continuation of application No. 11/906,636, filed on Oct. 3, 2007.

(51) Int. Cl. G05D 11/00; G05B 15/00

(52) U.S. Cl. 700/284; 700/275

(57) ABSTRACT

Method and system enable remote control of utilities and other scheduled products and services using data communications networks. Information provided by third parties is obtained to control the use of utilities, products and/or services. Obtained information is analyzed to create or modify a schedule for using power, water or any other utility, product or service that depends on or relates to such data. Analysis results in schedule modification or creation, which affects use.

### INVENTION PRIORITY

The present invention is a continuation of and claims priority and benefit of U.S. patent application Ser. No. 11/906,636 filed on Oct. 3, 2007 and entitled “NETWORK-BASED OPTIMIZATION OF SERVICES” and of provisional patent application Ser. No. 60/849,074, entitled “NETWORK-BASED OPTIMIZATION OF SERVICES” filed Oct. 2, 2006 both applications by Seth J. Gardenswartz and incorporated herein by reference in their entirety.

### FIELD OF THE INVENTION

The present invention is generally related to Internet-based remote data management and system control. More particularly, the present invention is related to remote control of services, e.g., utilities, using data communications networks. The present invention is also related to the use of information provided by third parties to control the use of services such as utilities, products or maintenance.

### BACKGROUND

The following patent and patent application publications are herein incorporated by reference for their teaching and as background for the present invention:

U.S. Pat. No. 6,823,239 issued Nov. 23, 2004 to Siemenski entitled “Internet-enabled central irrigation control”;

US Application 20040225412A1 published Nov. 11, 2004 by Alexanian entitled “Irrigation controller water management with temperature budgeting”;

US Application 22058499A1 published May 16, 2002, by Ortiz entitled “Systems, methods and apparatuses for brokering data between wireless devices and data rendering devices”.

### SUMMARY OF THE EMBODIMENTS

The present invention enables the remote control of utilities and other scheduled products and services using data communications networks.

It is a feature of the present invention to the use of information provided by third parties to control the use of utilities, products or services.

It is another feature of the present invention to use data from third parties related to environmental, municipal, financial, regulatory or other changing conditions to create or modify a schedule for using power, water or any other utility, product or service that depends on or relates to such data.

It is yet another feature of the present invention to transmit instructions to a remote switching devise for execution of such instructions.

It is another feature of the present invention to use third party forecasted weather data and reported weather data available over a wide area network, including without limitation the internet or a direct data feed modify irrigation schedules.

It is yet another feature of the present invention to use third party evapotranspiration data available over a wide area network, including without limitation the internet or a direct data feed, to modify irrigation schedules or utility usage at a central processing point.

It is another feature of the present invention to read municipal utility rates and schedules over a wide area network, including without limitation the internet or a direct data feed, to optimize utility usage by scheduling use of such utilities when rates are lowest.

It is yet another feature of the present invention to read municipal utility schedules and guidelines over the internet and to estimate utility expense for such utilities based on user's scheduled use of such utilities and, if desired, forecasted weather using third party weather data.

It is another feature of the present invention to read municipal utility schedules and guidelines (like no water or low power usage days) over a wide area network, including without limitation the internet or a direct data feed, in order to conform to required or recommended usage guidelines for such utilities set forth by any governmental unit, agency or private conservation entity.

It is yet another feature of the present invention to read a user's utility meter directly or over the internet to evaluate the system's function and modify usage.

It is another feature of the present invention to permit a user to program the system to turn any product or service on or off, or modify a usage schedule therefore, by selecting an event to trigger such change and identifying a source for the data available via the internet from third party data providers.

It is yet another feature of the present invention to use third party weather and other data available over the internet to create or modify feeding, housing or activity schedules for livestock.

It is another feature of the present invention to use third party weather and other data available over the internet to create or modify supply or inventory programs for businesses.

It is yet another feature of the present invention to use third party weather and other data available over the internet to create or modify staffing schedules for businesses.

It is another feature of the present invention to use proprietary user data together with other third party data available over the internet to create or modify schedules for utility usage, inventory, staffing or logistics.

It is yet another feature of the present invention to use store a schedule or operation in a central site, modify such schedule or operation at such central site, and then transmit instructions for the execution of such schedule or operation to a remote switching device so the remote switching device does not require substantial memory.

### BRIEF DESCRIPTION OF THE DRAWINGS

FIG. 1 is a block diagram of a utility control system in accordance with an exemplary embodiment of the present invention as an irrigation system;

FIG. 2 is a sequence diagram of the operation of an irrigation controller coupled to a weather station in accordance with an exemplary embodiment of the present invention; and

FIG. 3 is a data flow diagram showing process used by the present invention to acquire, process and transmit data in accordance with an exemplary embodiment of the present invention.

### DETAILED DESCRIPTION OF THE INVENTION

Disclosed are method and systems for automatically adjusting product or service usage (e.g., building utilities) for maximum efficiently or effectiveness by using forecasted and reported environmental conditions (such as weather conditions or utility rate schedules and municipal restrictions) available over a wide area network, including without limitation the Internet or a direct data feed for each location defined by the user (Local Data).

An exemplary embodiment described herein describes a system and methods using the present invention for the optimization of water use in landscape irrigation Local Data.

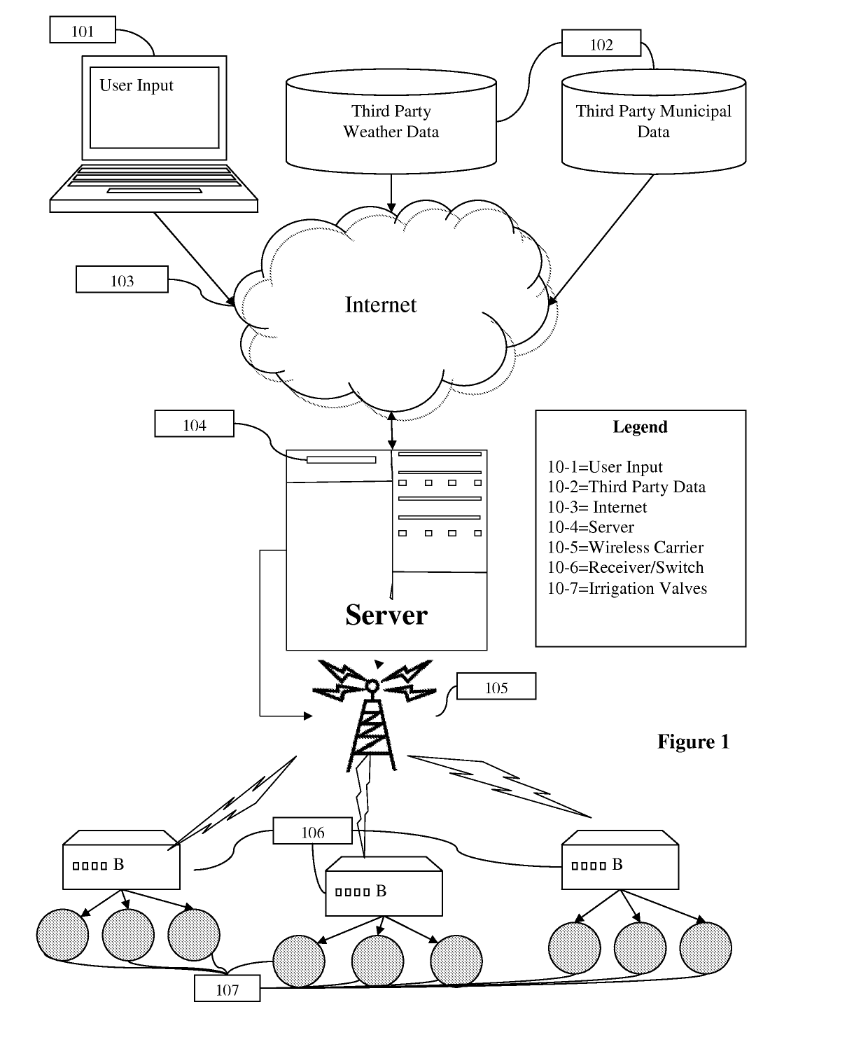

FIG. 1 shows the major components of the present invention. The system consists of User Input or preferences 101, Third Party Data 102, the Internet 103, a server 104, a wireless carrier or network 105, a receiver and switching device 106 and irrigation valves 107.

The user input includes a desired watering schedule or periodic water budget for each irrigation site administered by the system. Users also define what Local Data will trigger a modification of the schedule or budget described above (a “Modification Event”). Users will further define the types of modifications that will be triggered by certain Modification Events depending on particular data (“Modification Algorithms”). Cumulatively these schedules, preferences and Modification Algorithms will be referred to as the “User Data.”

Third party data consists of weather data, municipal data (including rate schedules and individual usage data) and any other data available to the system over the internet. Cumulatively this data will be referred to as “Third Party Data.”

The system uses the Internet to collect User Data and Local Data. Data can be collected via an XML feed like the one the National Weather Service is currently operating, by screen scraping, data mining, or other data extraction techniques or by using a wireless “DataCasting” network like that of Ambient Devices. The invention transmits this data to a fourth component of the system, an Irrigation Server. The Irrigation Server stores all of the User Data and the Local Data as well as processing modifications to the schedules and budgets.

The present invention uses a wireless carrier to transmit and potentially collect data. Different exemplary embodiments of the present invention may used, any type of wireless carrier including but not limited to: one way paging, two-way paging, Cellular Digital Packet Data (CDPD), Global System for Mobile Communications (GSM), General Packet Radio Service (GPRS), Code Division Multiple Access (CDMA), or datacasting network that the system uses to transmit irrigation instructions to the sites for irrigation.

The Switch is the component that executes the irrigation schedule as defined by the user and modified by the system. It is capable of receiving signals from the wireless carrier. It reads these signals and uses them to open and close valves for each irrigation zone defined up by the User Data. One potential feature of the Switch is a limited memory for storage of a “default” watering schedule, which would run in the event the irrigation switch did not receive an instruction from the Irrigation Server.

The irrigation valves themselves will open and close according to the instructions send to the switch from the server.

### Operation of the Invention.

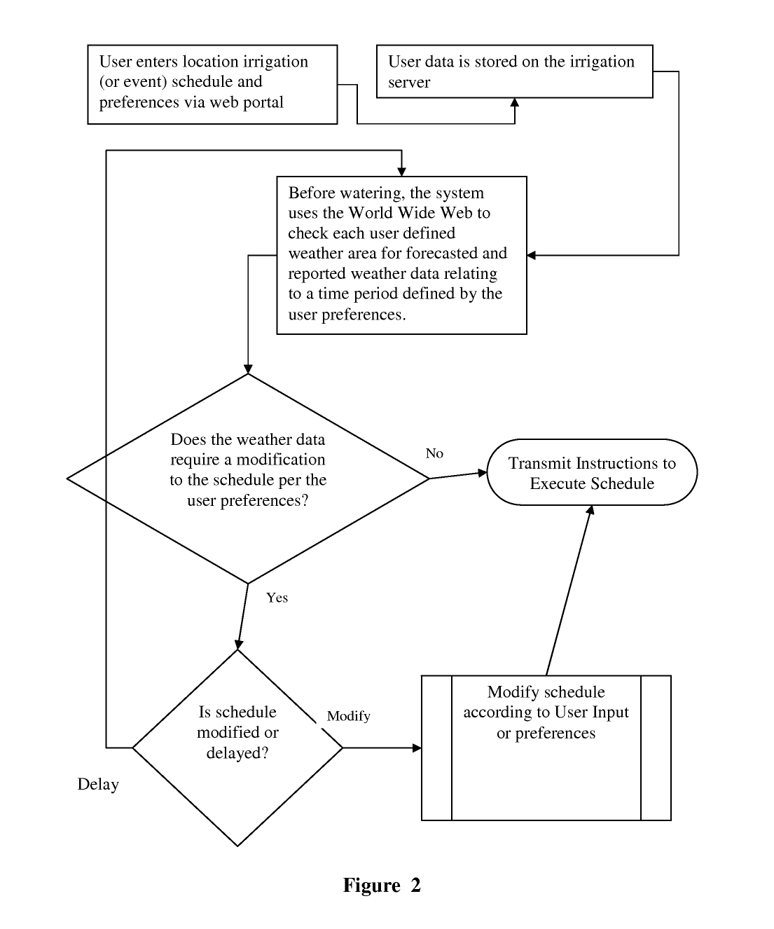

FIG. 2 shows the process beginning when a user logs on to the system and enters a desired irrigation schedule or water budget via an internet connection for a particular location. That location is identified to a particular weather zone. A weather zone is a defined area, for which the system can access Local Data, which pertains only to that zone. For example, the Dallas-Fort Worth metro area may be reported as a single weather area, but the user can identify a weather zone that is much smaller, like a particular neighborhood or suburb as long as there is reliable Third Party Data for such zone. A user irrigating multiple such locations would be put each location into a group according to the weather zones as described above. So if a user has five sites with two or more in a single weather zone such user could defined common preferences and Modification Algorithms for all sites in that zone (like a rain shutdown) even if other components of the User Data differ from site to sit. The user also enters Modification Algorithms. For example, the user may specify a two hour delay in the irrigation schedule if rain is forecast with an 80% probability or greater in any single weather zone. Thus a user is able to predicate certain modification to a programmed irrigation schedule based on any Modification Event identified by such user.

The user's site locations, weather zones and preference data are stored on an irrigation server (“Server”). Shortly before an irrigation schedule is programmed to begin the system will check the Local Data. The Local Data is analyzed against the User Data to check for a Modification Event. If there is none, the system transmits the instructions to the Switch, which opens and closes the irrigation valves in the order and for the duration stipulated by the User Data. If there is a Modification Event the system uses the Modification Algorithm to determine what action is taken. If it is a delay the system waits for the delay period and then returns to point where it checks Local Data before sending irrigation instructions. If the action demanded by the Modification Event is a modification, like a reduction in the amount of time each valve is opened, the system modifies the schedule per the Modification Algorithm and then sends the modified instructions to the Switch.

The invention has several advantages over the current state of the art. First is its extensive use of third party data. Many systems use individual weather stations, which are expensive and require installation and maintenance. The third party data is widely available from public and private web site. It can be used at no cost in many cases or for a relatively nominal fee.

Another important feature is ease of use. Most irrigation controllers are manually set up and adjusted using an analog switch or by manually entering a schedule into a static piece of equipment. Consequently most irrigation systems are adjusted only twice per year. The initial set up of the invention can be done via telephone or internet portal. These options permit the use of an interactive menu as well as email notices to the user. The internet portal gives the system the advantage of a graphic user interface that is easy to navigate, learn use and modify. Furthermore, if a user enters preferences that so permit, the system will self adjust not only for day to day weather variations but for seasonal changes (including local time changes) as well. Thus, while a prudent user will evaluate the effectiveness of the systems on a periodic ongoing basis, once programmed, the system will address irrigation needs indefinitely.

The invention is also more efficient in its use of hardware than much of the prior art. Most irrigation systems use an irrigation controller that holds the irrigation schedule in a local memory at the irrigation site. This adds to the cost and the complexity of the irrigation controller. Large installations with multiple controllers must each be individually programmed and maintained or have the scheduled updated via a master controller. By contrast the Switch requires almost no memory or local programming controls. It is simply a switching device enabled by a wireless connection. Other than a backup program all of the primary instructions are stored and modified in the irrigation server, which delivers instructions to the Switch in “real time” as the schedule is programmed to execute. The only hardware the invention requires is a server and a wireless connection capable or transmitting instructions to the switch. Each irrigation site will require only an irrigation switch, which is enabled with a wireless receiver.

### Alternative Embodiments

The present invention is a process that uses data available over a wide area network like the Internet and uses this data to permit a user to program the system to turn any product or service on or off, or modify a usage schedule therefore, by selecting an data event to trigger such change and identifying a source for the data available via the internet from third party data providers.

### Alternative Embodiment 1

Another embodiment of the present invention is to use third party data available over the internet to shut down or modify usage of certain systems that consume utilities when the rates for such utilities reach predefined levels or when the provider of such utilities is experiencing a spike in demand that threatens a “brown out” or other event as defined by the user.

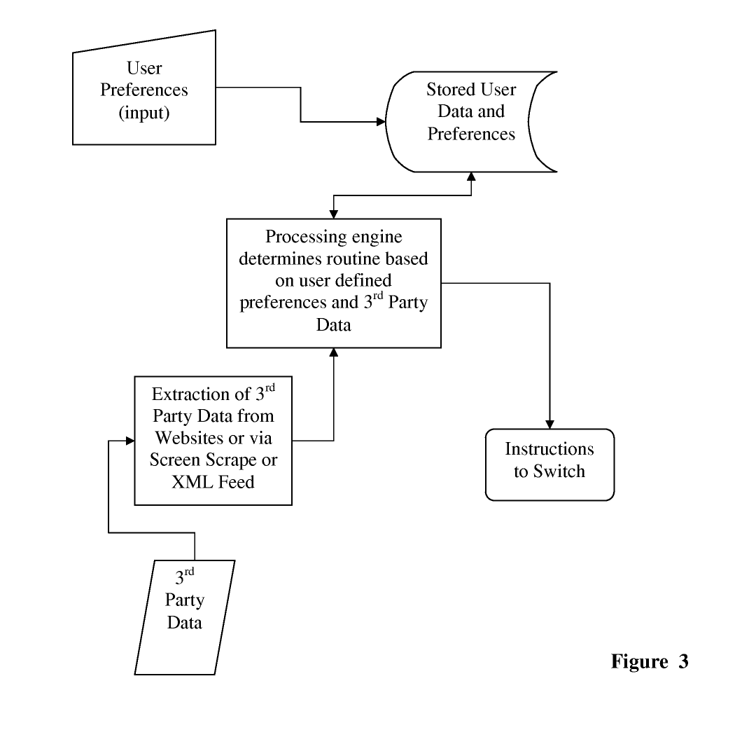

FIG. 3 shows the system would function in a manner very similar to the irrigation product described above except that instead of irrigation schedules being modified using third party weather data, it would modify power (or other utility usage) can be using utility data. The user enters its preferences over the Internet defining what data will be used as Local Data and what constitutes a Modification Event. The system may but need not control the day to day scheduled usage for such utility. In the case of a Modification Event the system can shut down or modify usage of the utility.

For example, the system can be used to optimize electrical power usage by running certain processes when rates are lowest and shutting down, or modifying usage when rates are highest. It could adjust the thermostat several times per day based on utility rates and forecasted usage of the building. It could cool a building to below the optimal temperature when rates are low in the morning, and then reset the thermostat to slightly higher levels thought the day as rates climb. When rates drop or there is no forecasted use the system will set the temperature appropriate for those conditions. The system can interact with local controls or data to facilitate such optimization. In some cases, the system may be able to operate the building controls from the server directly over the internet without need of a wireless network. However, the wireless enabled switch will ensure that operation is possible without an internet connection.

This is a substantial improvement upon the prior art. Many building controls can be set for certain schedules, which can be programmed based on rates, but the present invention automates this process. Furthermore, as rates change or building conditions change the present invention can react to such changes based on the User Data.

### Alternative Embodiment 2

Yet another embodiment is to use the present invention to read utility rate data as described above and use such data to predict a user's utility expense or usage based on such user's programmed utility use. Such embodiment could also use forecasted Local Data as described in the preferred embodiment to forecast modifications to the programmed utility use and predict usage using such modifications as part of the calculation.

### Alternative Embodiment 3

Additionally, another alternative embodiment for the present invention to adjust lighting, temperature or other building controls according user preferences by reading third party sunrise, sunset, forecasted temperature, precipitation or other weather data available over the internet via third party data providers.

### Alternative Embodiment 4

Additionally, another alternative embodiment for the present invention to use the process described in the preferred embodiment to create or modify feeding, housing or activity schedules for livestock.

Additionally, another alternative embodiment for the present invention to use the process described in the preferred embodiment to create or modify supply or inventory programs for businesses.

Additionally, another alternative embodiment for the present invention to use the process described in the preferred embodiment to create or modify staffing schedules for businesses.

Additionally, another alternative embodiment for the present invention to use the process described in the preferred embodiment to create or modify schedules for utility usage, inventory, staffing or logistics.

What is claimed is:

1. A system for optimizing and remotely controlling utility usage over data communications networks, comprising:
a utility usage schedule for timed utility usage by at least one utility using device;
a remote server connected to a data network that obtains information including at least one of a utility rate schedule and forecasted environmental conditions, wherein the remote server analyzes the information and determines to delay the utility schedule based on the information, and wherein after the delay the remote server analyzes the information again and determines to modify the utility usage schedule; and
a remote controller wherein the remote server implements the utility usage schedule by sending instructions to the remote controller and wherein the remote controller activates and deactivates the at least one utility using device.

2. The system of claim 1 wherein the information comprises forecasted environmental conditions and wherein the utility usage schedule is delayed based at least in part on the forecasted environmental conditions.

3. The system of claim 2 wherein the information further comprises reported environmental conditions and wherein the utility usage schedule is modified at least in part based on the reported environmental conditions.

4. The system of claim 3 wherein the system is an irrigation system, wherein the utility usage schedule is a watering schedule, wherein the forecasted environmental conditions comprises forecasted weather data and wherein the reported environmental conditions comprise reported weather data.

5. The system of claim 3 wherein the reported environmental conditions comprise evapotranspiration data.

6. The system of claim 5 wherein the information comprises third party information.

7. The system of claim 6 wherein the third party information is stored on a third party server.

8. The system of claim 7 wherein the third party information is read from a utility meter.

9. The system of claim 6 wherein the third party information is read from a utility meter.

10. The system of claim 1 wherein the information comprises municipal utility rate data.

11. The system of claim 10 wherein the third party information is read from a utility meter.

12. The system of claim 3 wherein the utility is an energy utility and wherein the utility using device is an energy using device.

13. The system of claim 12 wherein the information comprises forecasted weather data and reported weather data, and wherein the utility usage schedule is modified based at least in part on the reported environmental conditions.

14. A system for optimizing and remotely controlling water usage, the system comprising:
an irrigation schedule for timed irrigation by at least one irrigation device;
a remote server connected to a data network that obtains information comprising forecasted environmental conditions, wherein the remote server analyzes the information and determines to delay the irrigation schedule based on the information, and wherein after the delay the remote server analyzes the information again and determines to modify the irrigation schedule; and
a remote controller wherein the remote server implements the irrigation schedule by sending instructions to the remote controller and wherein the remote controller activates and deactivates the at least one irrigation device.

15. The system of claim 14 wherein the information comprises forecasted weather data wherein the irrigation schedule is delayed based at least in part on the forecasted weather data.

16. The system of claim 15 wherein the information further comprises reported weather data, and wherein the irrigation schedule is modified based at least in part on the reported weather data.

17. The system of claim 14 wherein the reported environmental conditions further comprise evapotranspiration data.

18. A system for optimizing and remotely controlling electricity, the system comprising:
a utility usage schedule for timed utility usage by at least one electric device;
a remote server connected to a data network that obtains information including at least one of a utility rate schedule and forecasted environmental conditions, wherein the remote server analyzes the information and determines to delay the utility schedule based on the information, and wherein after the delay the remote server analyzes the information again and determines to modify the utility usage schedule; and
a remote controller wherein the remote server implements the utility usage schedule by sending instructions to the remote controller and wherein the remote controller activates and deactivates the at least one utility electric device.

19. The system of claim 18 wherein the information comprises forecasted weather data, and wherein the utility usage schedule is delayed based at least in part on the forecasted environmental conditions.

20. The system of claim 19 wherein the information further comprises reported weather data, and wherein the utility usage schedule is modified based at least in part on the reported weather data.
